(19) United States
(12) Patent Application Publication
(10) Pub. No.: US 2004/0265051 A1
(43) Pub. Date: Dec. 30, 2004

(54) Connection device for an end of a control cable

(75) Inventors: Angelo Tancredi, Torino (IT); Salvatore Melis, Rivoli (Torino) (IT)

Correspondence Address: SUGHRUE MION, PLLC, 2100 PENNSYLVANIA AVENUE, N.W., SUITE 800, WASHINGTON, DC, 20037, US

(73) Assignee: SILA HOLDING INDUSTRIALE S.P.A.

(21) Appl. No.: 10/879,739

(22) Filed: Jun. 30, 2004

(30) Foreign Application Priority Data
Jun. 30, 2003 (IT) TO2003A000496

(51) Int. Cl. F16G 11/00

(52) U.S. Cl. 403/351

(57) ABSTRACT

The device, for connecting an end of a control cable to a control member, in particular to the gearshift lever of a motor-vehicle gearbox, includes: an outer body connectable to the control cable and having a through aperture; a bush insertable into the through hole of the body to be releasably locked in an assembly position; and a cover for closing the through aperture at the axially opposite side to that in which the bush is insertable. The bush is provided with resilient engagement means for cooperating with respective retaining members on the body so as releasably to lock the bush in the assembly position, and cam portions formed in one piece with the resilient engagement means. The cover is secured to the body for rotation about an axis of rotation coinciding substantially with the axis of the aperture and is provided with retaining means arranged to cooperate with the cam portions on the bush so that, upon rotation of the cover about its axis of rotation, the members cause the portions as well as the engagement means of the bush to deflect resiliently, thereby causing these latter to disengage from the retaining means on the body and allowing the bush to be removed from the body.

The present invention relates to a connection device for an end of a control cable of a so-called push-pull type. These devices are commonly used, in particular in the automotive field, for connecting one end of a control cable to a control member, such as the gearshift lever of a motor-vehicle gearbox, for example.

The connection device must provide an articulated connection between the end of the cable and the control member. To this end the device, which is generally fitted on the control member, for example onto an end of the gearshift lever, has a spherical seat into which the ball head of a pin fixed to an end of the control cable is to be snap engaged. In this way, a releasable connection between the cable and the control member is obtained.

German Patent Application DE 198 13 721 A1, for example, describes a terminal device designed to reduce the force required to insert the ball head of the pin associated with the control lever into the spherical seat formed in the cable terminal, without at the same time reducing the disassembly force and thereby risking the ball head becoming disengaged from its seat during operation. To this end, this known device includes:

an outer body connected to the control cable by a connection rod and having an aperture arranged perpendicular to the rod;

a pin with a ball head fitted onto the end of the control lever;

a sleeve inserted through the aperture of the outer body and having at least two first cavities and two second cavities defining a first, pre-assembly position and a second, assembly position, respectively;

a bush mounted slidably in the sleeve and having a spherical seat for receiving the ball head of the pin; in which the bush is provided with resilient retaining teeth for engaging in the cavities of the sleeve for locking the bush into the said two positions within the cavity in the terminal body.

With the bush in the first position (pre-assembly) the spherical seat can enlarge, due to the presence of slits, in order to snap engage the ball head of the pin. Upon displacing the bush into the second position (assembly), the entire portion of the bush forming the spherical seat is contained within the sleeve inside the terminal body and thus cannot enlarge to allow the ball head to disengage from its seat.

According to this known arrangement, in order to disconnect the end of the cable it is necessary to act on the resilient retaining teeth of the bush, preferably using a special tool, in order to disengage them from the cavities defining the assembly position in the sleeve.

The object of the present invention is to provide an end connection device for a control cable which overcomes the disadvantage of the prior art discussed above, making it possible to disconnect the bush from the sleeve easily, without the need for tools or instruments additional to the device.

This and other objects are achieved according to the invention by a cable end connection device having the characteristics defined in Claim 1.

Further characteristics and advantages of the device of the invention will become apparent from the detailed description which follows, given purely by way of non-limitative example with reference to the appended drawings, in which:

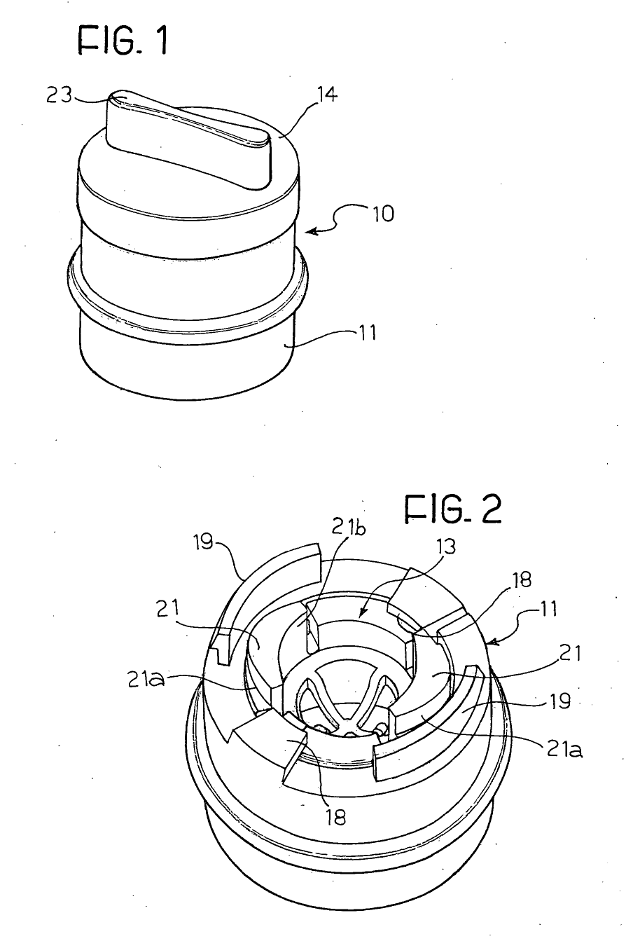

FIG. 1 is a perspective view of a cable end connection device according to the invention, in its assembled condition;

FIG. 2 is a similar view to that of FIG. 1, showing the device without its upper closure cover;

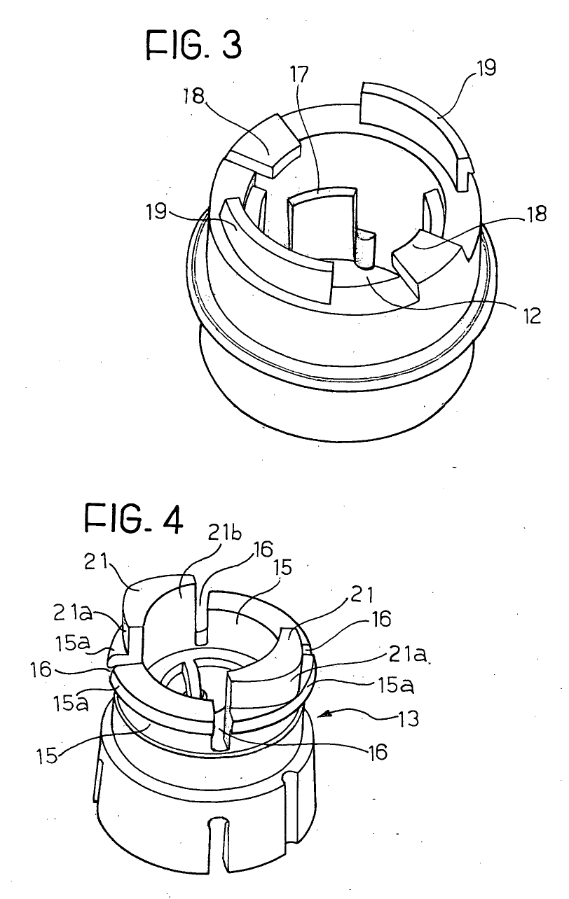

FIGS. 3 and 4 are perspective views of an outer body and a bush, respectively, which form part of the device of FIG. 1;

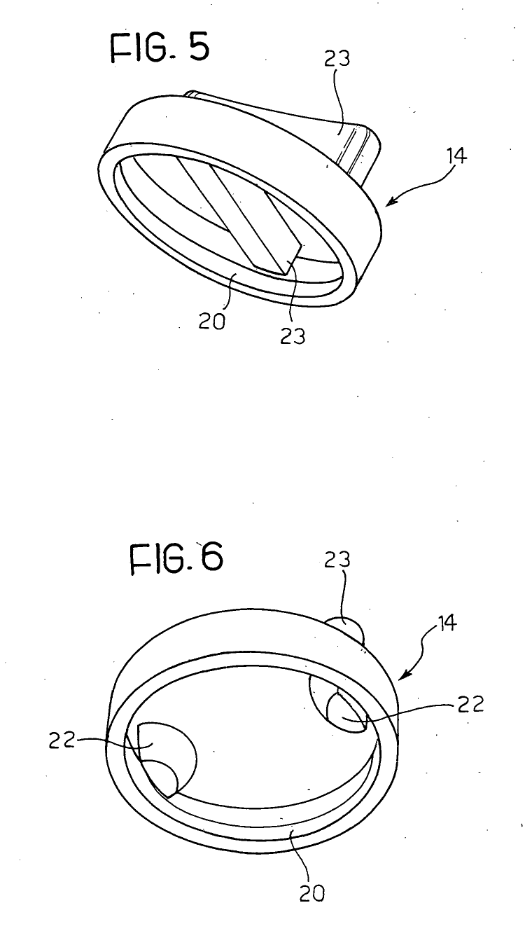

FIG. 5 is a perspective view of an upper closure cover for the device of FIG. 1;

FIG. 6 is a perspective view of a variant of construction of an upper closure cover for the device of FIG. 1;

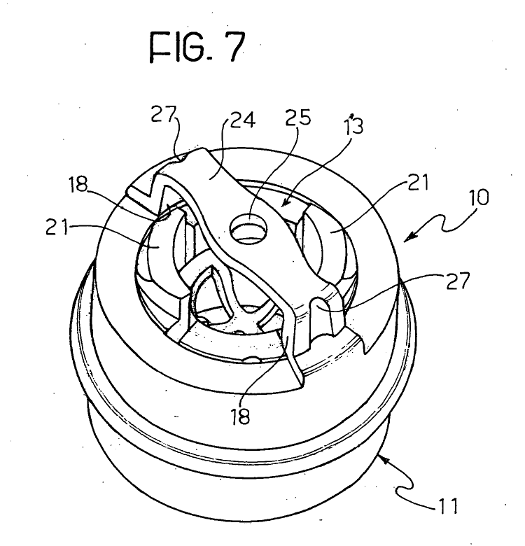

FIG. 7 is a perspective view of a cable end connection device according to a further embodiment of the invention, in its assembled condition and without the closure cover;

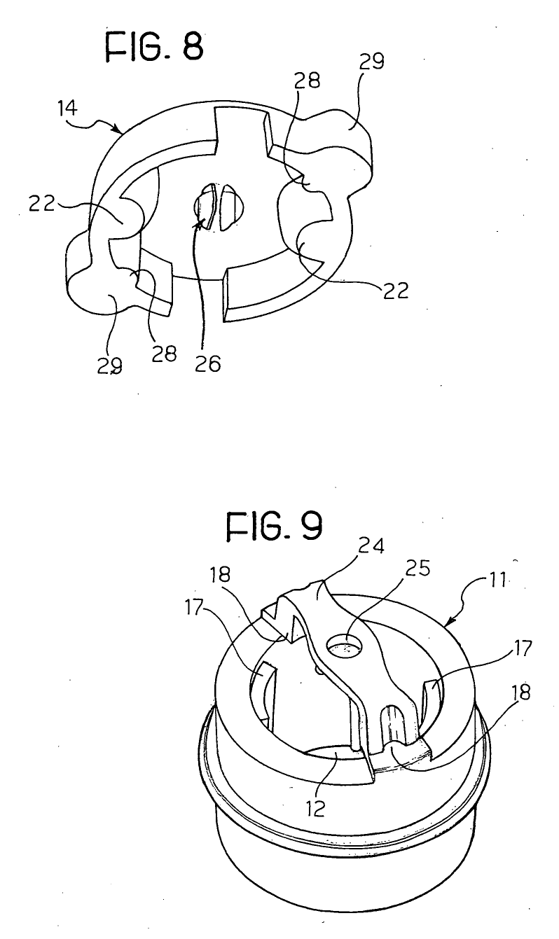

FIG. 8 is a perspective view of an upper closure cover for the device of FIG. 7; and

FIG. 9 is a perspective view of an outer body forming part of the device of FIG. 7.

With reference first to FIGS. 1 to 6, a cable end connection device according to the present invention is generally indicated 10. The device 10 includes an outer body 11, designed to be connected in a manner known per se, such as for example by means of a connection rod (not shown) to an end of a control cable (also not shown). The body 11 has a central through aperture 12, open at one (lower) end for insertion of a bush 13 and closed at the opposite (upper) end by a cover 14. Advantageously, though not necessarily, the body 11 is co-moulded with the connection rod, which is usually made of metal and arranged perpendicular to the axis of the aperture 12.

Advantageously the body 11 and the bush 13 are of the type described in the European Patent Application 04011348.2 in the name of the Applicant. These components will therefore not be described in detail here, only those portions which are strictly relevant to the present invention will be illustrated.

At the top, the bush 13 forms a resiliently deformable portion 15, subdivided by a plurality of axial slots 16 (four in the example illustrated) into a corresponding plurality of resiliently deformable limbs, provided with outwardly radial protuberances 15a operable to snap engage respective ramp-like projections 17 (only one of which is shown in FIG. 3) provided on the inner surface of the through aperture 12 of the body 11, so as to lock the bush 13 in its assembled position. Clearly, the slots 16 have the function to divide the upper portion of the bush 13 into resiliently deformable limbs, thereby facilitating the snap engagement of the protuberances 15a with the projections 17. In this way, when the bush is pressed upwards though the aperture 12, the deformable limbs of the upper portion of the bush bend radially inwards as a result of the protuberance 15a sliding on the ramp surface of the projections 17 on the body 11, until the protuberance moves beyond these projections. In this position, the bush 13 is locked axially against downward movement in the aperture 12, thus ensuring that the device remains in its assembled condition.

The body 11 also forms a pair of radial projections 18, extending radially inwards from the upper rim of the aperture 12 so as to define, in cooperation with the protuberances 15a, an upper travel limit position for the bush 13, corresponding to the assembled position described above. There are provided also a pair of detent portions 19 which extend vertically from the top of the body 11 and are designed to secure the cover 14 to the body 11, cooperating resiliently with a raised circumferential rim 20 formed on the cover (FIGS. 5 and 6). The snap engagement between the cover 14 and the body 11 by means of the detents 19, though locking the cover axially, allows it to rotate relative to the body about the axis of the aperture 12 for disassembling the device, as will be explained later.

The bush 13 also forms a pair of cam portions 21 extending vertically from the top of a pair of opposite sectors of the radial protuberance 15a. Each cam portion 21 is defined radially between an outer surface 21a having a profile shaped approximately as a limb of a hyperbola and an inner surface 21b with a profile forming an arc of a circle continuous with that of a corresponding sector of radial protuberance 15a, and is delimited circumferentially by a pair of adjacent slots 16. The outer surface 21a of each of the cam portions 21 is arranged to cooperate with a corresponding retaining member 22 formed by the cover 14 in such a way that, upon rotation of the cover about an axis of rotation substantially coinciding with the axis of the aperture 12, the member 22 causes the cam portions 21 to be deflected resiliently in an axially inward direction. As a result of this resilient deformation, the radial protuberance 15a, which is formed in one piece with the cam portions 21, disengages from the projections 17 defining the assembly position of the device and thus allows the bush 13 to be extracted from the body 11.

The retaining member 22 of the cover 14 can be formed as a single bar-shaped element which extends diametrally (FIG. 5) and can act simultaneously with its two ends on both the cam portions 21. Alternatively, a pair of retaining members 22 can be provided (FIG. 6), formed in the shape of half discs, for example, and arranged on diametrically opposite sides so as to act simultaneously on the pair of cam portions 21.

In this way, clearly, it is no longer necessary to use a specific additional tool or instruments in order to disassemble the device, but it is sufficient to rotate the cover 14 about its own axis. In order to facilitate rotation of the cover 14 in order to disassemble the device, the top of the cover forms a grip portion 23 on which an operator can act easily.

A second embodiment of a device according to the present invention is shown in FIGS. 7 to 9, in which parts and elements identical or corresponding to those in the preceding figures have been given the same reference numbers.

With reference to these figures, the body 11 of the device is provided at its top with a bridge portion 24 which extends between the two diametrically opposite radial projections 18 of the body 11 and acts as a support for the cover 14. This portion 24 has a central hole 25 for a clip member for the cover 14, constituted by a pair of substantially semi-conical snap engagement teeth 26 which project downwardly from the centre of the cover. The portion 24 has a pair of semi-cylindrical notches 27 at its diametrically opposite ends for receiving corresponding semi-cylindrical radial projections 28 formed by the cover 14 in order to ensure that the cover is correctly centred on the body of the device. As in the case of the preceding embodiment, in order to allow the radial protuberance 15a on the bush 13 to disengage from the projections 17 on the body 11, the bush 13 forms at its top a pair of cam portions 21, substantially similar to those described above, designed to cooperate with a pair of retaining members 22 on the cover 14, like those of FIG. 6, which extend radially inwardly and are offset angularly with respect to the centering projections 28.

In order to facilitate rotation of the cover 14, this latter is also provided with a pair of grip members 29 in the shape of handles projecting radially outwardly and aligned with the centering projections 28.

The operating principle of this second embodiment of the device is similar to that of the first embodiment described above. The only difference is that now the cover 14 is secured to the body 11 by virtue of the engagement of the snap-engagement teeth 26 on the cover in the hole 25 in the bridge portion 24 of the body. In this case as well, anyway, the means for securing the two components (cover and body) define the axis of rotation of the cover relative to the body.

Naturally, the principles of the invention remaining unchanged, embodiments and manufacturing details can be varied widely with respect to those described and illustrated purely by way of non-limitative example.

What is claimed is:

1. A connection device, for connecting one end of a control cable to a control member, in particular to the gearshift lever of a motor vehicle gearbox; the device comprising
an outer body connectable to the control cable and having a through aperture;
a bush insertable into the through aperture in the body to be releasably locked in an assembly position; and
a cover for closing the through aperture on the side axially opposite that through which the bush is insertable;
the bush having resilient engagement means able to cooperate with respective retaining members of the body so as releasably to lock the bush in the assembly position;
wherein
the bush is provided also with cam portions formed in one piece with the resilient engagement means;
the cover is secured to the body for rotation about an axis of rotation which substantially coincides with the axis of the aperture;
the cover is provided with retaining means arranged to cooperate with the cam portions of the bush in such a way that, upon rotation of the cover about the said axis of rotation, the retaining means cause the cam portions, as well as the engagement means of the bush, to be resiliently deflected, thus causing these latter to disengage from the retaining members of the body and allowing the bush to be removed from the body.

2. The device of claim 1, wherein the body and the cover are also provided with respective clip means for securing the cover to the body in such a way as to allow the cover to be rotated about the said axis of rotation.

3. The device of claim 2, wherein the said clip means for securing the cover to the body include detents extending vertically from the end of the body facing the cover and a relieved circumferential rim formed by the cover and snap-engageable by the detents.

4. The device of claim 2, wherein the said clip means for securing the cover to the body include stop teeth projecting from the centre of the cover and a bridge portion formed in one piece with the body and extending diametrally from the end of the body facing the cover, the said bridge portion having a central hole into which the stop teeth are engageable.

5. The device of claim 1, wherein the resilient engagement means of the bush are constituted by a plurality of resiliently deformable limbs forming outwardly radial protuberances, and the said cam portions on the bush extend upwardly from a pair of diametrically opposite limbs.

6. The device of claim 5, wherein the said retaining means of the cover are formed by a bar-shaped element extending diametrally and operable to act simultaneously with its two ends on a pair of cam portions.

7. The device of claim 5, wherein the said retaining members of the cover are formed by a pair of half-disc elements arranged on diametrically opposite sides so as to act simultaneously on a pair of cam portions.

8. The device of claim 1, wherein the cover is provided with grip means on which an operator can act in order to rotate the cover.
